(19) United States
(12) Patent Application Publication
(10) Pub. No.: US 2023/0112029 A1
(43) Pub. Date: Apr. 13, 2023

(54) Assembly for a Traction Battery With a Protective Unit, Traction Battery and Motor Vehicle

(71) Applicant: Bayerische Motoren Werke Aktiengesellschaft, Muenchen (DE)

(72) Inventors: Simon HABERL, Deisenhofen (DE); Thomas HARSCH, Muenchen (DE); Frank TENFELDE, Muenchen (DE)

(21) Appl. No.: 17/910,021

(22) PCT Filed: May 10, 2021
(86) PCT No.: PCT/EP2021/062278

§ 371 Date: Sep. 8, 2022

(30) Foreign Application Priority Data
Jun. 8, 2020 (DE) 10 2020 115 132.2

(51) Int. Cl. H01M 50/242; H01M 50/209; H01M 50/30; H01M 50/289; B60K 1/04

(52) U.S. Cl. CPC H01M 50/242; H01M 50/209; H01M 50/30; H01M 50/289; B60K 1/04; H01M 2220/20

(57) ABSTRACT

An assembly for a traction battery of a motor vehicle includes a battery module having a cell composite formed by a plurality of battery cells, wherein degassing regions of the battery cells are located on an upper side of the cell composite for letting out a hot gas from a cell housing of the battery cells; a battery component arranged in a vertical direction above the battery module, such that the upper side of the cell composite is facing an underside of the battery component; and a protective unit having a sheet-metal-type protective region for protecting the battery component from the hot gas and a frame-type support region connected to the protective region. The battery component is secured to the support region and the protective region is arranged between the underside of the battery component and the upper side of the cell composite.

### BACKGROUND AND SUMMARY OF THE INVENTION

The invention relates to an assembly for a traction battery of a motor vehicle. The assembly comprises at least one battery module having a cell composite formed of a plurality of battery cells, wherein degassing regions of the battery cells are located on an upper side of the cell composite, for the release of a hot gas from a cell housing of the battery cells. The assembly further comprises at least one battery component, which is arranged in a vertical direction above the at least one battery module, such that the upper side of the cell composite faces an underside of the at least one battery component. The invention further relates to a traction battery and to a motor vehicle.

The present case is focused on a rechargeable traction battery for electrically-propelled motor vehicles, which can be constituted, for example, in the form of a high-voltage energy store. Traction batteries of this type customarily comprise a plurality of battery components, for example battery modules and control devices, which are arranged in a battery housing of the traction battery. Battery modules comprise cell composites of battery cells which, in turn, comprise degassing regions for the release of a fault-related hot gas from a cell housing of the battery cells. Degassing regions can be arranged, for example, on cell covers of the cell housing, which form an upper side of the cell composite. If a further battery component is arranged above a battery module, this battery component, in the event of a malfunction in at least one battery cell in the battery module which is arranged thereunder, will receive hot gas from the latter. This results in high thermal loading of the battery component. Moreover, a particle stream, which is carried by the hot gas, can result in mechanical loading of the battery component. Accumulations of these particles can additionally reduce clearances and creepage distances, thus increasing the risk of short-circuits in the battery component.

The object of the present invention is the protection of battery components of a traction battery of a motor vehicle against the negative effects of a release of hot gas, in a simple and reliable manner.

This object is fulfilled by an assembly, a traction battery and a motor vehicle having the features according to the claimed invention.

An assembly according to an embodiment of the invention for a traction battery of a motor vehicle comprises at least one battery module having a cell composite formed of a plurality of battery cells, wherein degassing regions of the battery cells are located on the upper side of the cell composite, for the release of a hot gas from the cell housing of the battery cells. The assembly moreover comprises at least one battery component, which is arranged in a vertical direction above the at least one battery module, such that the upper side of the cell composite faces an underside of the at least one battery component. The assembly further comprises a protective unit, having a sheet metal-type protective region for protecting the at least one battery component from the hot gas of the at least one battery module, and a frame-type support region which is connected to the protective region. The at least one battery component is secured to the support region, and the protective region is thus arranged between the underside of the at least one battery component and the upper side of the cell composite.

The invention further relates to a traction battery for a motor vehicle, having at least one assembly according to an embodiment of the invention and having a battery housing, in which the at least one assembly is arranged. The rechargeable traction battery or traction accumulator is particularly configured in the form of a high-voltage energy store, and delivers electric drive energy for an electric drive machine of the motor vehicle. The traction battery comprises the battery housing, in the interior of which the at least one assembly is arranged.

The at least one battery module of the assembly comprises the cell composite, which is formed by the battery cells. The battery cells can be, for example, prismatic cells, cylindrical cells or pouch cells. In the case of prismatic cells or pouch cells, these are arranged along a stacking direction to form a cell composite in the form of a cell stack or cell block. The battery cells comprise degassing regions or degassing elements, for example rupture membranes or valves, which are arranged on the upper side of the cell composite, and thus on an upper side of the battery module. By way of the degassing regions, in the event of a malfunction of a battery cell, for example an internal short-circuit in the battery cell, hot gas generated in the cell housing can escape into the interior space of the battery housing. Heat and particles are transported by the hot gas, which can result in the thermal and mechanical loading of the at least one battery component which is located in the flow path of the hot gas. The at least one battery component can be configured, for example, in the form of a further battery module, or in the form of a control apparatus or control device of the traction battery. The at least one battery component is arranged above the at least one battery module. The at least one battery module and the at least one battery component are thus stacked one on top of another in the vertical direction. As the underside of the at least one battery component faces the upper side of the cell composite, and thus the degassing regions, it is located in the flow path of the hot gas.

The assembly further comprises the protective unit. The protective unit is designed to prevent the thermal and mechanical loading of the overlying battery component by hot gas from the battery module, and to prevent any resulting particle-related short-circuits. To this end, the protective unit comprises a sheet metal-type protective region or protection plate. A sheet metal-type protective region is to be understood as a region of an arbitrary material, the width and length of which are substantially greater than the thickness thereof. The protective region is supported by the support region of the protective unit, to which the at least one battery component is also secured. To this end, the protective region and the support region can be configured integrally, for example wherein they are mutually bonded in an inseparable and non-destructive manner, for example by welding. For example, the support region can be formed of steel or aluminum, and can be welded to the metallic protection plate which is formed, for example, of sheet steel or sheet aluminum. The protective unit can also be configured as a modular component, wherein the protective region and the support region are detachably bonded in a non-destructive manner, for example by screwing. To this end, the support region can be, for example, a cast component.

The at least one battery component is mechanically bonded to the protective unit, wherein the at least one battery component is secured to the frame-type support region or the frame-type support structure. The support region can be configured, for example, to project in a vertical direction from an edge of the protective region, such that the protective unit is essentially configured with a trough shape. The at least one battery component can thus be accommodated in the protective unit, wherein the protective region covers the underside of the at least one battery component, and the support region overlaps with regions of the at least one battery component which extend in the vertical direction. The protective unit thus encloses some regions of the at least one battery component.

The protective region, in the fitted state of the at least one battery component, is arranged above the at least one battery module, between the at least one battery module and the at least one battery component. The protective region particularly forms an enclosed surface vis-à-vis the at least one battery module, in the lower plane. The protective region thus protects the underside of the at least one battery component against any direct incidence of hot gas, and particularly against any accumulation of electrically conductive particles on the at least one battery component in the upper plane, and thus against thermal or mechanical loading. In particular, at least the protective region comprises a heat-resistant and/or electrically insulating material. In particular, the protective region comprises a metallic protection plate, for example of steel or aluminum, which is coated with a heat-resistant and/or electrically insulating material, for example mica, or a special plastic, or a ceramic, for example by adhesive bonding or hot caulking. It can also be provided that the protective region is formed of the heat-resistant material, for example mica. By way of the heat-resistant material, the input of heat to the at least one battery component associated with the hot gas can at least be reduced. By way of the electrically insulating material, short-circuits caused by accumulations of particles from the hot gas can be prevented.

By way of a protective unit of this type, the at least one battery component can be protected against hot gas from the at least one battery module in a simple and space-saving manner. The protective unit can advantageously enhance the robustness of the traction battery.

In a further development of the invention, the protective region, on a side facing the upper surface of the cell composite, comprises a groove-type guide structure, which is designed to capture and divert the hot gas. The guide structure diverts the hot gas, particularly laterally, perpendicularly to the vertical direction. For example, the guide structure can divert the hot gas in the direction of a degassing unit of the battery housing, via which hot gas can be evacuated from the interior space of the battery housing to an ambient environment of the battery housing.

It can also be provided that the protective region comprises a reinforcement structure, in order to increase the rigidity of the protective unit. The reinforcement structure can comprise, for example, stiffening beads, which are embossed into the protection plate. By way of the reinforcement structure, the configuration of the protective region is particularly resistant to mechanical loads associated with hot gas.

It has proved to be advantageous if the protective region, for the reduction of heat transfer between the battery module and the battery component is arranged with a spacing from the upper side of the cell composite to form a first air gap, and/or with a spacing from the underside of the at least one battery component to form a second air gap. The protective region is thus arranged with a spacing from the battery module and/or from the battery component and, in consequence, does not engage directly with the battery module and/or the battery component. By way of the at least one air gap, thermal transfer resistance between the battery module and the battery component can be increased, and any input of heat to the battery component associated with the hot gas can be reduced accordingly. The air gap can assume a height, for example, of 20 mm.

In one embodiment of the invention, the at least one battery component is secured to the support region in a suspended arrangement to form the second air gap. By way of the suspended arrangement, the battery component is arranged with a spacing from the protective region. It can thus be provided that the battery component is configured in the form of at least one further battery module having a cell module frame for the retention of a cell composite of the further battery module, wherein the support region at least extends along tie-rods of the cell module frame, and wherein retaining elements are arranged on the tie-rods, by way of which the at least one further battery module is secured to the support region. The cell module frame comprises, for example, two pressure plates, which are arranged on a front side and a reverse side of the cell composite of the further battery module, and two tie-rods, which are connected for the purposes of the tensioning of battery cells of the further battery module by way of the pressure plates, and are arranged on two opposing lateral regions of the cell composite. The tie-rods can comprise, for example, wing-shaped retaining elements, by way of which the tie-rods can be secured to the support region, for example by screwing in place.

The invention moreover includes a motor vehicle having a traction battery according to an embodiment of the invention. The motor vehicle is configured in the form of an electric or hybrid vehicle.

Embodiments proposed with reference to the assembly according to the invention, and the advantages thereof, apply correspondingly to the traction battery according to the invention and to the motor vehicle according to the invention.

Further features of the invention proceed from the claims, the figures and the description of the figures. Features and combinations of features specified in the preceding description, and/or features and combinations of features represented in the figures only, are not only applicable in the respective combination indicated, but also in other combinations, or in isolation.

The invention is described in greater detail hereinafter with reference to an exemplary embodiment, and in consideration of the drawings.

### BRIEF DESCRIPTION OF THE DRAWINGS

FIG. 1 shows a schematic representation of a first embodiment of an assembly for a traction battery of a motor vehicle, in an overhead view.

FIG. 2 shows a schematic representation of a second embodiment of the assembly, in an overhead view.

FIG. 3 shows a schematic representation of a third embodiment of the assembly, in a front view.

FIG. 4 shows a schematic representation of a first embodiment of a protective unit of the assembly.

FIG. 5 shows a schematic representation of a second embodiment of the protective unit.

FIG. 6 shows a schematic representation of a third embodiment of the protective unit.

FIG. 7 shows a schematic representation of a fourth embodiment of the protective unit.

### DETAILED DESCRIPTION OF THE DRAWINGS

In the figures, identical and functionally equivalent elements are identified by the same reference symbols.

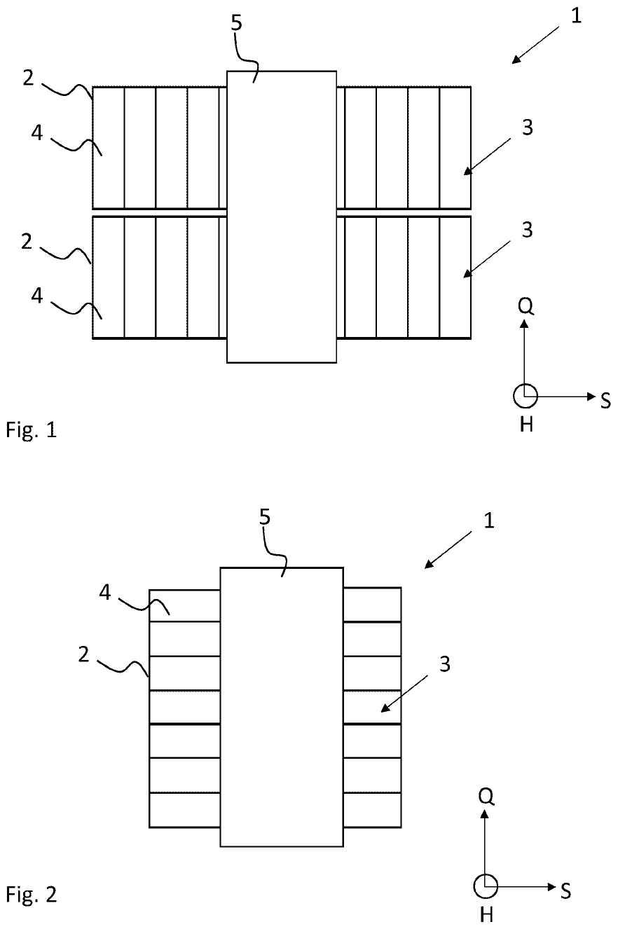

FIG. 1 and FIG. 2 show different embodiments of an assembly 1 for a traction battery of a motor vehicle, in an overhead view. The assembly 1 is arranged in an interior space of a battery housing of the traction battery, and comprises at least a first battery module 2, having a cell composite 3 formed of battery cells 4. In this case, the battery cells 4 are prismatic cells, which are stacked along a stacking direction S to form the cell composite 3. The stacking direction S also corresponds here to a longitudinal direction, along which the battery module 2 extends. According to FIG. 1, the assembly comprises two battery modules 2, which are arranged next to one another in a transverse direction Q, perpendicularly to the stacking direction S. The assembly moreover comprises a battery component 5, which is arranged in a vertical direction H (perpendicular to the drawing plane) above the at least one battery module 2. According to FIG. 1, the battery component 5 extends along the transverse direction Q, and thus partially overlaps the two underlying battery modules 2. According to FIG. 2, the battery component 5 extends along the stacking direction S, and thus partially overlaps the underlying battery module 2.

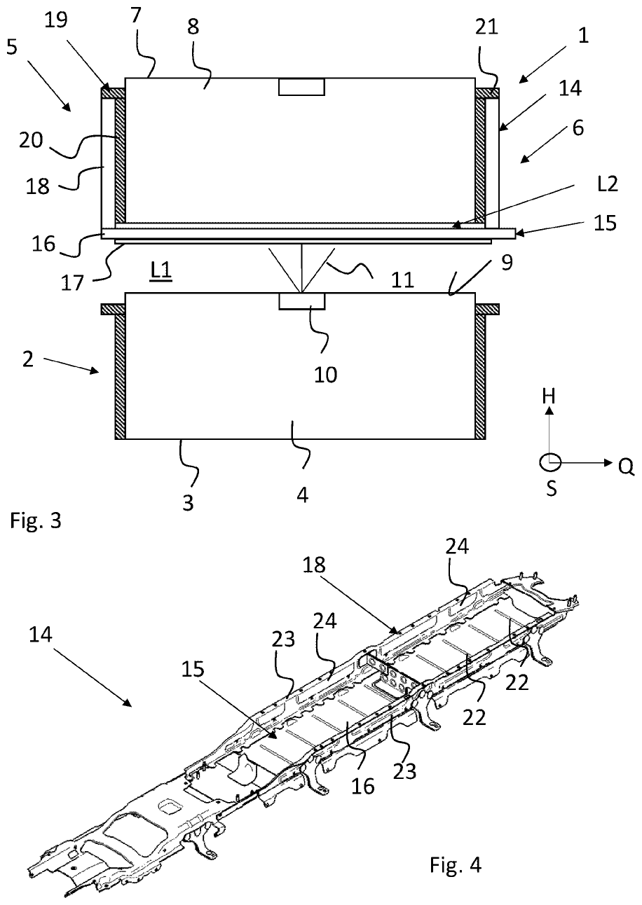

FIG. 3 shows an assembly 1, in a front view. In this case, the battery component 5 is configured in the form of a second battery module 6, which comprises a cell composite 7 formed of battery cells 8. On an upper side 9 of the cell composite 3 of the first battery module 2, degassing regions 10 of the battery cells 4 are located, by way of which, in the event of a malfunction, hot gas 11 can be evacuated from the battery cells 4. As the battery component 5 is arranged in a vertical direction H above the first battery module 2, an underside 12 of the battery component 5 is located in a flow path of the hot gas 11. In order to prevent the generation by the hot gas 11 of any thermal or mechanical overloading in the battery component 5, the assembly 1 further comprises a protective unit 14. The protective unit 14 comprises a sheet metal-type protective region 15 which, in this case, comprises a metallic protection plate 16, for example of sheet aluminum or sheet steel. The protective region 15 is arranged between the upper side 9 of the cell composite 3 and the underside 12 of the battery component 5, and forms a barrier for the hot gas 11. Rather than the underside 12 of the battery component 5, in the event of a malfunction, hot gas is thus applied to the protective region 15. In this case, the protection plate 16, on a side facing the upper side 9, is coated with a heat-resistant and/or electrically insulating material 17, for example mica. In order to reduce an input of heat from the first battery module 2 to the battery component 5, the protective region 15 is arranged here with a spacing from the upper side 9 of the cell composite 3 to form a first air gap L1.

The protective unit 14 further comprises a frame-type support region 18 which, in this case, is oriented along the vertical direction H and projects upwards from the protective region 15. The battery module 5 is secured to the support region 18. In this case, the second battery module 6 comprises a cell module frame 19 for tensioning the battery cells 8. The cell module frame 19 comprises tie rods 20, which extend along the stacking direction S, above lateral regions of the cell composite 7. Wing-shaped retaining elements 21 are arranged to project outwardly from the tie-rods 20, by way of which the second battery module 6 can be secured to the support region 18. For example, the retaining elements 21 can be fitted to the support region 18, and screwed in place, such that the battery module 6 can be secured to the protective unit 14 in a suspended arrangement. As a result, the underside 12 is also arranged with a spacing from the protective region 15 to form a second air gap L2. Accordingly, neither the first battery module 2 nor the second battery module 6 is engaged in direct contact with the protective region 15, such that the thermal resistance of the heat transfer path between the first battery module 2 and the second battery module 6 is increased.

Different embodiments of the protective unit 14 are represented in FIG. 4 to FIG. 7. According to FIG. 4, the protective unit 14 is configured, for example, in the form of a one-piece steel component. To this end, the support region 18 is configured as a steel structure and the protective region 15 comprises a steel protection plate 16, wherein the support region 18 and the protective region 15 are bonded by welding. In this case, the protective region 15 moreover comprises a structure 22, which can be configured, for example, in the form of a reinforcement structure and/or a guide structure. The guide structure is comprised, for example, of groove-type recesses in a side of the protective region 15 facing the upper side 9 of the first battery module 2, which can capture and laterally divert the hot gas 11. In this case, the support region 18 comprises two guide rails 23, to which a plurality of second battery modules 6 can be secured. The guide rails 23 can extend along the tie-rods 20, and can be mechanically bonded to the retaining elements 21 of the cell module frame 19, in order to secure the second battery module to the protective unit 14. As the support region 18, in this case, is formed of steel, it is particularly stable and, in the interests of reducing the weight of the protective unit 14, can incorporate cut-outs 24, which are arranged, for example, in the region of the guide rails 23.

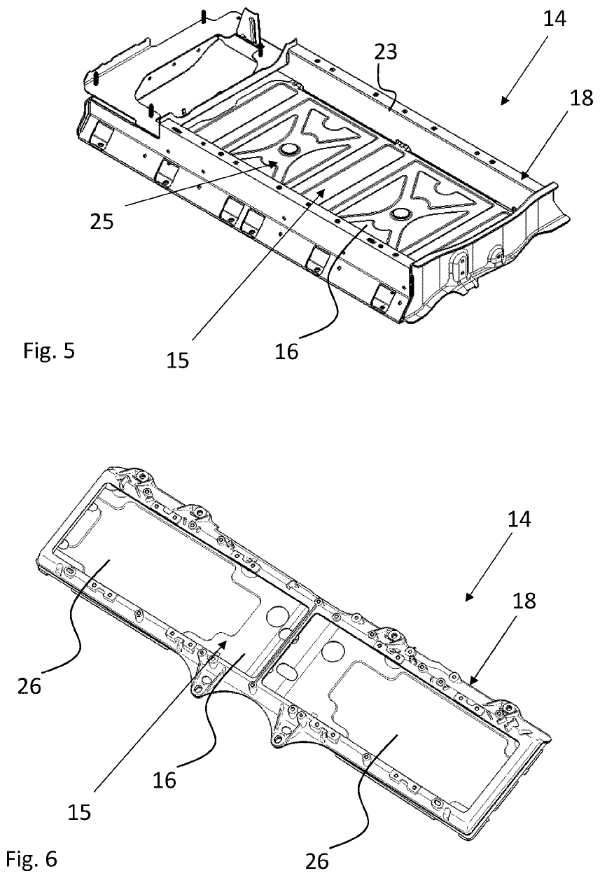

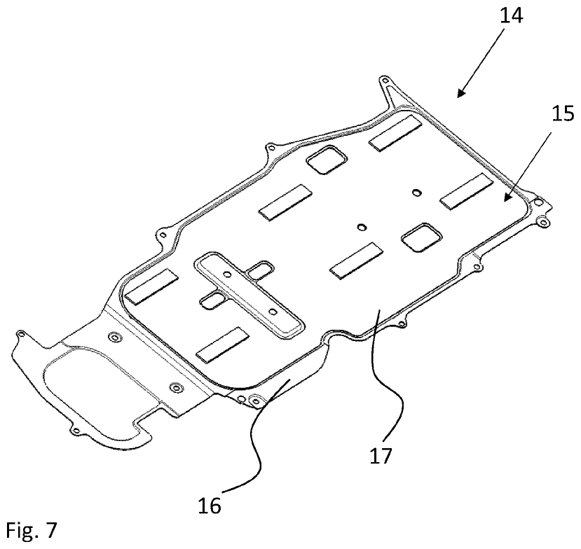

According to FIG. 5, the protective unit 14 is likewise configured in one piece, wherein the support region 18 is formed, for example, of aluminum, and the protective region 15 is constituted by a steel protection plate 16 which is welded to the support region 18. In this case, the protective region 15 comprises a structure 22 having stiffening beads 25 for the enhancement of the mechanical stability of the protective unit 14. According to FIG. 6, the protective unit 14 is configured with a multi-piece construction, wherein the support region 18 is screwed to the protective region 15. The support region 18 can be configured, for example, as a cast component. In this case, the protective region 15 can comprise recesses 26, in which the battery components 5 can be arranged. FIG. 7 shows a protective unit 14 from below. The side facing the upper side 12 of the first battery module 2 is thus represented to which, in this case, the heat-resistant and/or electrically insulating material 17 is applied.

1-10. (canceled)

11. An assembly for a traction battery of a motor vehicle, the assembly comprising:
at least one battery module having a cell composite formed of a plurality of battery cells, wherein degassing regions of the battery cells are located on an upper side of the cell composite, for release of a hot gas from a cell housing of the battery cells;
at least one battery component arranged in a vertical direction above the at least one battery module, such that the upper side of the cell composite faces an underside of the at least one battery component; and
a protective unit comprising:
a sheet metal-type protective region for protecting the at least one battery component from the hot gas of the at least one battery module, and
a frame-type support region which is connected to the protective region, wherein:
the at least one battery component is secured to the support region, and
the protective region is arranged between the underside of the at least one battery component and the upper side of the cell composite of the at least one battery module.

12. The assembly according to claim 11, wherein:
the protective region, on a side facing the upper surface of the cell composite, comprises a groove-type guide structure which is configured to capture and divert the hot gas.

13. The assembly according to claim 11, wherein:
the protective region comprises a reinforcement structure in order to increase a rigidity of the protective unit.

14. The assembly according to claim 11, wherein:
at least some areas of the protective region comprise a heat-resistant and/or electrically insulating material.

15. The assembly according to claim 11, wherein:
the at least one battery component is a control device of the traction battery and/or a further battery module.

16. The assembly according to claim 11, wherein:
the protective region, in order to reduce a transfer of heat between the first battery module and the at least one battery component, is arranged with a first spacing from the upper side of the cell composite to form a first air gap, and/or is arranged with a second spacing from the underside of the at least one battery component to form a second air gap.

17. The assembly according to claim 16, wherein:
the at least one battery component is secured to the support region in a suspended arrangement to form the second air gap.

18. The assembly according to claim 17, wherein:
the at least one battery component is configured in a form of at least one further battery module having a cell module frame for retention of a cell composite of the further battery module,
the support region at least extends along tie-rods of the cell module frame, and
retaining elements are arranged on the tie-rods, by way of which the at least one further battery module is secured to the support region.

19. A traction battery for a motor vehicle, the traction battery comprising:
the assembly according to claim 11, and
a battery housing in which the assembly is arranged.

20. A motor vehicle comprising the traction battery according to claim 19.
